(19) United States
(12) Patent Application Publication
(10) Pub. No.: US 2023/0219564 A1
(43) Pub. Date: Jul. 13, 2023

(54) METHOD FOR PERFORMING AN EVASIVE MANEUVER

(71) Applicant: Robert Bosch GmbH, Stuttgart (DE)

(72) Inventors: Michael Baumann, Leonberg (DE); Mostafa Alavi, Stuttgart (DE)

(21) Appl. No.: 18/074,300

(22) Filed: Dec. 2, 2022

(30) Foreign Application Priority Data
Jan. 10, 2022 (DE) 10 2022 200 138.9

(51) Int. Cl. B60W 30/09; B60W 50/14

(52) U.S. Cl. CPC B60W 30/09; B60W 50/14

(57) ABSTRACT

A method for performing an evasive maneuver using a control device. A lane model is created for a time interval on the basis of received measurement data from at least one sensor. An incident corridor, within which an evasive maneuver is possible within the time interval, is ascertained based on the received measurement data and/or the created lane model. An evasion path is planned within the ascertained incident corridor. The control commands for longitudinal guidance and/or transverse guidance of a vehicle for traveling along the evasion path are generated on receipt of a trigger incident within the time interval. A stable lane model for at least one time interval is saved at least temporarily. A stable lane model from a past time interval is used to ascertain the incident corridor if a lane model from a current time interval is unstable.

### CROSS REFERENCE

The present application claims the benefit under 35 U.S.C. § 119 of German Patent Application No. DE 10 2022 200 138.9 filed on Jan. 10, 2022, which is expressly incorporated herein by reference in its entirety.

### FIELD

The present invention relates to a method for performing an evasive maneuver. The present invention furthermore relates to a control device, to a computer program and to a machine-readable storage medium.

### BACKGROUND INFORMATION

The automated assistance function provided by evasion assist or “Evasive Steering Support (ESS)” increases traffic safety by the driver of a vehicle at risk of collision being assisted to make steering movements which will implement an evasive maneuver.

To enable evasion assist to assist the driver, continuous planning of an evasion path is needed. The corresponding information is provided by a vehicle control unit. The vehicle control unit in turn requires data about an available incident corridor, within which the evasion path can be implemented.

This incident corridor may be ascertained on the basis of a situation analysis and behavior strategy, wherein a lane model is used for this purpose. The availability of evasion assist within any one time interval is dependent on a stable lane model.

A stable lane model cannot be provided for every time interval, however, since the corresponding sensor data fusion and model fusion can be impaired in particular in highly dynamic traffic situations. The causes of this may be impaired measurement data from camera sensors and radar sensors or lane models which are incompatible with highly dynamic traffic scenarios.

### SUMMARY

An object of the present invention includes providing a method for performing an evasive maneuver which may be reliably implemented even in highly dynamic traffic scenarios.

This object may be achieved by means of features of the present invention. Advantageous configurations of the present invention are disclosed herein.

According to one aspect of the present invention, a method is provided for performing an evasive maneuver, in particular using a control device.

According to an example embodiment of the present invention, in one step, a lane model is created for a time interval on the basis of received measurement data from at least one sensor. To this end, measurement data ascertained by camera sensors, radar sensors, lidar sensors, ultrasonic sensors, ultrasonic sensor arrays, infrared sensors and the like may be received and evaluated.

An incident corridor, within which an evasive maneuver is possible within the time interval, is ascertained on the basis of the received measurement data and/or the created lane model.

In a further step, an evasion path is planned within the ascertained incident corridor, the control commands for longitudinal guidance and/or transverse guidance of a vehicle for traveling along the evasion path being generated on receipt of a trigger incident within the time interval.

In particular, a vehicle control unit may carry out longitudinal guidance and/or transverse guidance on the basis of the evasion path and control the vehicle along the evasion path or assist the driver in the corresponding control operation. For example, the driver's steering movements may be intensified or accelerated, whereby the evasive maneuver can be implemented more quickly in order to terminate a collision risk.

Preferably, a stable lane model for at least one time interval is saved at least temporarily, possibly in a memory of the control device.

The lane model is characterized for an individual lane or for a plurality of lanes for example by polylines. These represent the boundaries of lanes and/or of a carriageway. Depending on the course of the lanes, it is possible to model curves, intersections and slip roads or exits with the polylines.

In particular, the lane model for an individual lane may be bounded by two polylines extending parallel to one another and bounding the sides of the lane. The vertices of the two polylines are placed symmetrically to a virtual, middle camber line.

A lane model for an intended time interval is stable when it can be carried out in error-free manner and yields robust results.

The lane model cannot be carried out in error-free manner if it is based on incomplete measurement data or on measurement data from inaccurate or decalibrated sensors. Robust results of the lane model are those results which can realistically map a traffic situation. If measurement data are incomplete or inaccuracies in the measurement data or the sensors deviate too sharply, a resultant lane model cannot map the traffic situation adequately and may thus not yield robust results. As a corollary, complete input data or measurement data, which have a minimum degree of accuracy, are needed, which are correctly linked together in the course of sensor data fusion.

In addition to errors by the sensors, errors in the sensor data fusion may also make it impossible to carry out the lane model for one time interval or to carry it out sufficiently robustly. In this case, a lane model may be identified as unstable if error messages are received at sensor level.

For example, the lane model may be pre-emptively defined as unstable, depending on the traffic situation, in particular in the case of particularly dynamic traffic situations, such as intersections or high traffic volumes during rush hours in the centers of conurbations, and temporarily excluded from use, since the lane model created for the time interval cannot be reliably carried out, or not over the entire time interval. In contrast, a stable lane model may be carried out in error-free manner over the entire time interval and thus robustly.

Moreover, errors in the vehicle sensor system, such as for example decalibration or defects, or weather phenomena disadvantageously affecting particular types of sensor, may lead to an error message. Such error messages may be generated by the control device due to an absence of measurement data or due to inaccurate measurement data. Such an error message or warning may for example serve as an indicator of an unstable lane model.

According to an example embodiment of the present invention, a stable lane model from a past time interval is used to ascertain the incident corridor if a lane model from a current time interval is unstable. In particular, a stored lane model may be at least temporarily “frozen” for use at a later point in time or time interval. The time interval may for example be 1 ms or a plurality of milliseconds long.

In order to get around the problem of instability of the lane model and the possibly unstable ESS corridor, the last “stable” or reliable version of the lane model may be used for implementation of the evasive maneuver. This is possible by saving a copy of the lane model with each time step or time interval.

Starting with the time interval of evasion assist activation, the saved lane model may be loaded from the memory in the case of a highly dynamic traffic scenario.

A further aspect of the present invention provides a control device, wherein the control device is configured to carry out the method. The control device may for example be a control device in the vehicle, a control device outside the vehicle or a server unit outside the vehicle, such as for example a cloud system.

The control device may, for example, have a vehicle control module, a module for situation analysis and behavioral strategy, a module for creating and fusing lane models and the like.

Furthermore, one aspect of the present invention provides a computer program which includes commands that, in response to execution of the computer program by a computer or a control device, causes the latter to carry out the method according to the invention. A further aspect of the present invention provides a machine-readable storage medium on which the computer program according to the invention is stored.

The vehicle may in this case be assisted, partially automated, highly automated and/or fully automated or driverless, as per the German Federal Highway Research Institute (BASt) standard.

The control device may be arranged in a mobile unit, which may be assisted, partially automated, highly automated and/or fully automated or driverless, as per the BASt standard.

“Freezing” of the last stable lane model is preferably limited only to the lane model. Further object information, such as the dynamic limits of the incident corridor, may furthermore be continuously updated.

Other functions such as an automatic cruise control system (CCS) or automatic emergency braking (AEB) do not use the last saved lane model and are thus able to function independently thereof.

In one exemplary embodiment of the present invention, a stable lane model from a past time interval is adapted to a current time interval on the basis of the received measurement data relating to a vehicle movement. In this way, the last stable lane model is corrected or compensated, for example by taking account of the ego-motion of the vehicle since the last time interval. In this way, the position of the last stable lane model may be adapted to a new vehicle position.

According to a further embodiment of the present invention, a stable lane model for at least one time interval is saved at least temporarily while an evasion assist function is activated. As a result of this measure, the latest stably functioning or reliable lane model may be saved in a memory and used again when needed.

According to a further exemplary embodiment of the present invention, a distance traveled by the vehicle since the past time interval is ascertained. A stable lane model from a past time interval is preferably used to ascertain the incident corridor if the distance traveled is less than a virtual length of the last stable lane model.

A past time interval may for example be a last time interval, penultimate time interval and the like. In particular, a time interval may be configured such that a lane model created for the time interval has unlimited validity within this time interval. Transfer or adaptation of the lane model to new or later time intervals is here possible by adaptation based on consideration of the vehicle movement in the form of distance traveled.

The distance traveled may take a three-dimensional course, which also takes account of curves, inclines and descents.

“Freezing” of the last stable line model preferably proceeds only when evasion assist is activated. The duration of activation typically amounts to ˜1 s. The distance traveled during this time is generally less than the typical virtual length of the last stable lane model prior to activation of evasion assist.

According to a further embodiment of the present invention, a distance traveled by the vehicle since the past time interval is ascertained which exceeds the virtual length of the last stable lane model or is equal to the virtual length. In such cases, in which the traveled distance is approximately comparable to or greater than the length of the lane model, certain improvements can be taken into consideration which are described below.

According to a further exemplary embodiment of the present invention, which describes a mentioned improvement, impaired confidence in the lane model is signaled or a warning message generated on activation of an evasion assist function. Thus, a communication about low trust or low confidence in the lane model may be taken into consideration as a metric, if the estimated distance traveled by the vehicle during impending ESS activation or activation of the evasion assist is longer than or comparable to the virtual length of the received lane model prior to activation of the evasion assist.

According to a further embodiment of the present invention, a further improvement is described in which the lane model quality of the current time interval is checked, wherein the last stable lane model is replaced by the lane model of the current time interval or updated on the basis thereof if the quality of the lane model exceeds a limit value. As a result of this measure, the quality of the received lane model can be checked for each time interval. Updating of the frozen or last stable lane model can then be considered if this quality lies over a given threshold value.

According to a further exemplary embodiment of the present invention, which mentions a further improvement, an age of the last, saved, stable lane model is ascertained, wherein the validity of the last stable lane model expires if the age exceeds a limit value. The age of the lane model is thus defined as a metric or a measured value which decides as to the validity of the lane model. If the age limit value is exceeded, the last stable lane model thus loses its validity and may for example be deleted from the memory.

Preferred exemplary embodiments of the present invention are explained in greater detail below with reference to greatly simplified schematic representations shown in the Figures.

### BRIEF DESCRIPTION OF THE DRAWINGS

FIG. 1 is a schematic representation of a vehicle arrangement for illustrating a method according to the present invention according to one example embodiment.

FIG. 2 is a schematic flowchart for illustrating the method according to the present invention according to one example embodiment.

### DETAILED DESCRIPTION OF EXAMPLE EMBODIMENTS

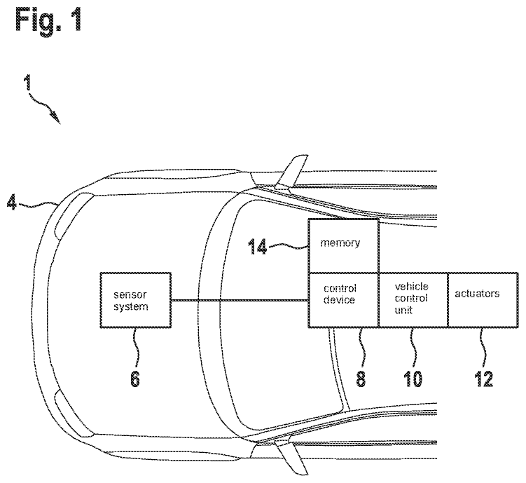

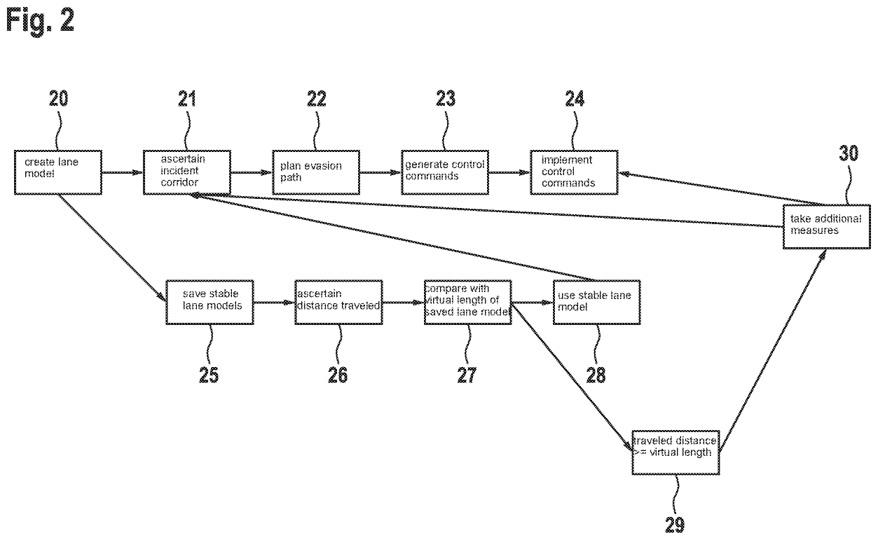

FIG. 1 is a schematic representation of a vehicle arrangement 1 for illustrating a method 2 according to the invention according to one embodiment. The method 2 is additionally described in FIG. 2.

The vehicle arrangement 1 has a vehicle 4 which may be assisted, partially automated, highly automated and/or fully automated or driverless, as per the BASt standard.

In particular, the vehicle 4 has evasion assist, which is able to assist the driver in evasive movements by appropriate control commands for longitudinal guidance and/or transverse guidance of the vehicle 4. To this end, the vehicle 2 has a sensor system 6, which for example comprises camera sensors, ultrasonic sensors, radar sensors, lidar sensors and the like.

The measurement data of the sensor system 6 are received and evaluated by a control device 8. The control device 8 may directly generate control commands for longitudinal guidance and/or transverse guidance of the vehicle 4 or prompt an additional vehicle control unit 10 to this end.

The vehicle control unit 10 may moreover drive corresponding actuators 12 of the vehicle 4 to implement corresponding control commands.

The control device 8 may have corresponding modules in the form of hardware and/or software which process the measurement data, create and/or fuse lane models, analyze the behavior of road users on the basis of the measurement data, detect and classify traffic situations and the like.

The control device 8 may preferably have an integral or external memory 14, which serves in at least temporary storage of data of any type and in storing models, such as for example lane models.

FIG. 2 shows a schematic flowchart for illustrating the method 2 according to the invention according to one embodiment. The method 2 serves in carrying out an evasive maneuver.

In one step 20, a lane model is created for a time interval on the basis of received measurement data from at least one sensor 6.

Stable lane models are saved 25 at least temporarily in the memory 14 for at least one time interval.

Then an incident corridor within which an evasive maneuver is possible within the time interval is ascertained 21 on the basis of the created lane model.

To ascertain the incident corridor 21, a stable lane model, saved in the memory 14 from a past time interval 25, is used 28 if a lane model from a current time interval is unstable.

To this end, a distance traveled by the vehicle 4 since the past time interval is ascertained 26 and compared 27 with a virtual length of the saved lane model 25.

The stable lane model 25 saved in the memory 14 is used 28 if the traveled distance of the vehicle 4 during an evasion assist activation period is less than the virtual length of the saved lane model.

An evasion path is planned in a further step 22 within the ascertained incident corridor. On receipt of a trigger incident within the time interval

23, control commands for longitudinal guidance and/or a transverse guidance of the vehicle 4 for traveling along the evasion path are generated by the control device 8. The corresponding actuators 12 of the vehicle 4 may then implement 24 the control commands.

If the traveled distance of the vehicle 4 during an evasion assist activation period is greater than or equal to the virtual length of the saved lane model 29, additional measures 30 may be taken. To this end, a lane model from the current time interval may for example nonetheless be used, if this has a quality which exceeds a limit value. Alternatively, warning messages about inadequate lane model quality may be generated.

What is claimed is:

1. A method for performing an evasive maneuver using a control device, the method comprising the following steps:
creating a lane model for a time interval based on received measurement data from at least one sensor;
ascertaining an incident corridor, within which an evasive maneuver is possible within the time interval, based on the received measurement data and/or the created lane model;
planning an evasion path within the ascertained incident corridor;
generating, on receipt of a trigger incident within the time interval, control commands for longitudinal guidance and/or transverse guidance of a vehicle for traveling along the evasion path;
wherein a stable lane model for at least one time interval is saved at least temporarily, a stable lane model from a past time interval being used to ascertain the incident corridor when a lane model from a current time interval is unstable.

2. The method as recited in claim 1, wherein a stable lane model from the past time interval is adapted to a current time interval based on the received measurement data, the received measurement data including measurement data relating to a vehicle movement.

3. The method as recited in claim 1, wherein a stable lane model is saved at least temporarily for at least one time interval during an activated evasion assist function.

4. The method as recited in claim 1, wherein a distance traveled by the vehicle since the past time interval is ascertained, wherein a stable lane model from the past time interval is used to ascertain the incident corridor when the distance traveled is less than a virtual length of a last stable lane model.

5. The method as recited in claim 1, wherein a distance traveled by the vehicle since the past time interval is ascertained which exceeds a virtual length of the last stable lane model or is equal to the virtual length.

6. The method as recited in claim 5, wherein impaired confidence in the lane model is signaled or a warning message generated on activation of an evasion assist function.

7. The method as recited in claim 5, wherein a quality of a lane model of a current time interval is checked, wherein the last stable lane model is replaced by the lane model of the current time interval or updated based on lane model of the current time model based on the quality of the lane model of the current time interval exceeding a limit value.

8. The method as recited in claim 1, wherein an age of a last, saved, stable lane model is ascertained, wherein a validity of the last stable lane model expires when the age exceeds a limit value.

9. A control device configured to perform an evasive maneuver using a control device, the control device configured to:
create a lane model for a time interval based on received measurement data from at least one sensor;
ascertain an incident corridor, within which an evasive maneuver is possible within the time interval, based on the received measurement data and/or the created lane model;
plan an evasion path within the ascertained incident corridor;
generate, on receipt of a trigger incident within the time interval, control commands for longitudinal guidance and/or transverse guidance of a vehicle for traveling along the evasion path;
wherein a stable lane model for at least one time interval is saved at least temporarily, a stable lane model from a past time interval being used to ascertain the incident corridor when a lane model from a current time interval is unstable.

10. A non-transitory machine-readable storage medium on which is stored a computer program for performing an evasive maneuver using a control device, the computer program, when executed by the control device, causing the control device to perform:
creating a lane model for a time interval based on received measurement data from at least one sensor;
ascertaining an incident corridor, within which an evasive maneuver is possible within the time interval, based on the received measurement data and/or the created lane model;
planning an evasion path within the ascertained incident corridor;
generating, on receipt of a trigger incident within the time interval, control commands for longitudinal guidance and/or transverse guidance of a vehicle for traveling along the evasion path;
wherein a stable lane model for at least one time interval is saved at least temporarily, a stable lane model from a past time interval being used to ascertain the incident corridor when a lane model from a current time interval is unstable.
